(19) United States
(12) Patent Application Publication
(10) Pub. No.: US 2026/0290156 A1
(43) Pub. Date: Sep. 24, 2026

(54) Systems and Methods for Connecting Machines with Pedestrians

(71) Applicant: Allen E. Nejah, San Jose, CA (US)

(72) Inventor: Allen E. Nejah, San Jose, CA (US)

(21) Appl. No.: 19/658,497

(22) Filed: Apr. 25, 2026

Related U.S. Application Data
(63) Continuation-in-part of application No. 19/291,582, filed on Aug. 5, 2025.
Application No. 19/291,582 is a continuation-in-part of application No. 19/007,197, filed on Dec. 31, 2024, now Pat. No. 12,612,957.
Application No. 19/007,197 is a continuation-in-part of application No. 18/199,916, filed on May 19, 2023, now abandoned.
(60) Provisional application No. 63/344,518, filed on May 20, 2022.
(60) Provisional application No. 63/616,755, filed on Dec. 31, 2023.
(60) Provisional application No. 63/679,572, filed on Aug. 5, 2024.

(51) Int. Cl. G08G 1/01; F16H 59/14; F16H 59/38; F16H 59/44; F16H 59/60; F16H 59/70; F16H 61/02

(52) U.S. Cl. CPC G08G 1/0141; F16H 59/14; F16H 59/38; F16H 59/44; F16H 59/60; F16H 59/70; F16H 61/0213; G08G 1/0112; F16H 2061/0234; F16H 2061/0241

(57) ABSTRACT

The present disclosure provides systems and methods for planning and directing movement of a movable item. A processing unit receives object data from one or more sensors, networked nodes, mapped data, or other sources and determines whether an object is a movement-relevant object. The processing unit generates one or more signals based on the object data to control movement of the movable item, provide an alert, or both, thereby reducing the risk of a dangerous situation. In some embodiments, the movable item comprises a vehicle, and the movement-relevant object comprises another vehicle, a pedestrian, a person, or infrastructure.

### CROSS-REFERENCE TO RELATED APPLICATIONS

This application claims the benefit as a Continuation In Part of U.S. application Ser. No. 19/291,582, filed on 5 Aug. 2025, by the present inventor, entitled “Robotic Gearbox with Predictive Gear Selection,” which claims the benefit of U.S. Provisional Application Number 63/679,572, filed on 5 Aug. 2024, by the present inventor, entitled “Robotic Gearbox with Predictive Gear Selection,” and U.S. application Ser. No. 19/007,197, filed on 31 Dec. 2024, as a Continuation In Part, by the present inventor, entitled “Segmented Gear Synchronization System,” which claims the benefit as a Continuation In Part of U.S. application Ser. No. 18/199,916, filed on 19 May 2023, by the present inventor, entitled “Systems and Methods for Connecting Machines, such as Bikes and Vehicles, with Pedestrians,” which claims the benefit of U.S. Provisional Application Number 63/344,518, filed on 20 May 2022, by the present inventor, entitled “Systems and Methods for Connecting Machines, such as Bikes and Vehicles, with Pedestrians.” U.S. application Ser. No. 19/007,197, filed on 31 Dec. 2024, also claims the benefit of U.S. Provisional Application Number 63/616,755, filed on 31 Dec. 2023, by the present inventor, entitled “Segmented Gear Synchronization System.” Each and every application to which this application claims the benefit, and each and every application to which those applications claim the benefit, are hereby incorporated by reference in their entirety for all allowable purposes, including the incorporation and preservation of any and all rights to patentable subject matter of the inventor, such as features, elements, processes and process steps, improvements, and their descriptions that may supplement or relate to the subject matter described herein.

### BACKGROUND OF THE INVENTION

Multiple modes of transportation can be utilized simultaneously. The co-existence of multiple modes of transport and movement, and the concurrent operation of multiple types of vehicles or machine for transportation, may enhance the movement of people and objects or items through an environment.

### SUMMARY OF THE INVENTION

The present disclosure provides systems and methods for transportation. In one aspect, the present disclosure provides smart bikes and connected bikes that can enhance a rider's ability to navigate through an environment safely and efficiently. The smart bikes and connected bikes disclosed herein may be configured to sense, detect, and/or communicate with other vehicles, objects, pedestrians, or infrastructure in the vicinity, and to (1) provide information to a rider on the vehicles, objects, pedestrians, or infrastructure in the vicinity, and/or (2) adjust an operation of the rider's bike to achieve a desired riding condition. In some non-limiting embodiments, the information provided to the rider may be used to enhance rider safety, or to connect the rider with other individuals associated with a group or social community.

In one aspect, the present disclosure provides a system comprising a communication device coupled to a vehicle. In some embodiments, the communications device may be integrated with the vehicle. The communication device may allow the vehicle to connect to and/or communicate with a plurality of nodes via a network. In some embodiments, each of the plurality of nodes may be associated with a movement-relevant object, in movement-relevant proximity. (See “movement-relevant object” and “movement-relevant proximity”, defined and explained below, as used in this disclosure.)

In some embodiments, the vehicle may comprise a processing unit coupled to the vehicle. The processing unit may be configured to generate a signal based on object data received from one or more of the plurality of nodes. In some embodiments, the object data comprises a position of the object, a velocity of the object, a heading of the object, an elevation of the object, a type of the object, a unique identification of the object, or any combination thereof. In some cases, the signal may control an operation of the vehicle, provide an alert to a passenger of the vehicle, provide an alert to the proximal object, or any combination thereof. In this disclosure, a “proximal object” is understood to be an object in “movement-related proximity” to the machine with the processing unit.

In some embodiments, the vehicle may comprise a bicycle, an automobile, a motorcycle, a tractor, a trailer, a camper, a snowmobile, or a boat. In some embodiments, the vehicle may comprise an autonomous vehicle or a semi-autonomous vehicle. In some embodiments, the vehicle may comprise an electric vehicle. In some embodiments, the vehicle may comprise a combustion engine (e.g., an internal combustion engine).

In some embodiments, the proximal object may comprise another vehicle (e.g., a proximal vehicle that is within a predetermined range of the vehicle), a proximal pedestrian, or a proximal infrastructure. In some embodiments, the proximal vehicle may comprise a bicycle, an automobile, a motorcycle, a tractor, a trailer, a camper, a snowmobile, or a boat. In some embodiments, the proximal infrastructure may comprise a road, a street, a traffic signal, a road sign, a sidewalk, a bridge, a tunnel, a fork, dead end, or a junction.

In some embodiments, at least one node of the plurality of nodes may be associated with a mobile device. In some cases, the mobile device may be associated with the proximal object. In some embodiments, at least one node of the plurality of nodes may be associated with a communication module. In some cases, the communication module may be associated with the proximal object.

In some embodiments, the processing unit may be configured to generate a signal based on object data received from one or more of the plurality of nodes. In some embodiments, the signal may control an operation of the vehicle. In some embodiments, the operation of the vehicle may correspond to an operation of a transmission of the vehicle, a steering of the vehicle, a speed of the vehicle, a gear of the vehicle, or any combination thereof.

In some embodiments, the processing unit may be configured to receive proximity data from an obstacle detection sensor. In some embodiments, the processing unit may be configured to generate the signal based on the proximity data. In some embodiments, the obstacle detection sensor may comprise, for example, a LIDAR unit, a RADAR unit, an optical sensor, an inductive sensor, a capacitive sensor, a magnetic sensor, an ultrasonic sensor, or any combination thereof.

In some embodiments, the processing unit may be configured to determine or detect a potential collision based on the object data, the proximity data, or both. In some embodiments, the processing unit may generate the signal if a potential collision is determined or detected.

In some embodiments, the processing unit may be configured to receive and transmit vehicle usage data to a platform. In some embodiments, the vehicle usage data may comprise a user identification and/or user riding data. In some embodiments, the vehicle may be configured to connect to a virtual or digital platform for health, community, and environmental awareness.

In some embodiments, the vehicle may comprise a unique ID associated with one or more physical or virtual tokens tied to a computing unit of the vehicle. In some embodiments, the one or more physical or virtual tokens may be usable to track one or more transactions involving the vehicle. The one or more transactions may involve, for example, reserving, renting, or leasing the vehicle for a certain period.

In another aspect, the present disclosure provides a system comprising: an automatic transmission for controlling an operation or a movement of a vehicle, wherein the automatic transmission comprises one or more microprocessors; a plurality of sensors; and a control board operatively coupled to the automatic transmission and/or the plurality of sensors, wherein the control board is configured to control an operation of the automatic transmission based on one or more measurements obtained using at least a subset of the plurality of sensors. In some embodiments, the vehicle may comprise an electric vehicle. In some embodiments, the vehicle may comprise a combustion engine (e.g., an internal combustion engine). In some embodiments, the vehicle may comprise a terrestrial vehicle, an aquatic vehicle, or an aerial vehicle. In any of the embodiments described herein, the automatic transmission can be used with any type of vehicle to improve the ability of the vehicle to adjust an amount of power or mechanical energy transferred to a drive unit, a rotor, an axle, or a wheel of the vehicle while minimizing energy loss (e.g., due to friction).

In some embodiments, the plurality of sensors may be integrated with the automatic transmission. In some embodiments, the plurality of sensors may be releasably coupled to the vehicle. In some embodiments, the plurality of sensors may comprise (i) one or more sensors integrated with the automatic transmission and/or (ii) one or more sensors attachable to the vehicle.

In some embodiments, the one or more measurements may comprise information or data on vehicle speed, velocity or acceleration, power output, wattage, or rotations per unit time. In some embodiments, the one or more measurements may comprise timing information associated with a movement of one or more gears operatively coupled to the automatic transmission.

In some embodiments, the system may comprise one or more switches. In some cases, the one or more switches may comprise a mechanical switch, an electronic switch, or an electromechanical switch. In some embodiments, the timing information may be obtained using the plurality of sensors, the one or more microprocessors of the automatic transmission, and/or the one or more switches. In some embodiments, the one or more switches may indicate whether a movable portion or section of the one or more gears is in contact with a drive unit of the vehicle. In some embodiments, the drive unit may comprise a belt or a chain. In some embodiments, the timing information may be usable to determine a time delay for expanding or contracting one or more gears operatively coupled to the automatic transmission.

In some embodiments, the automatic transmission may be configured to control a timing of an expansion or a contraction of one or more movable portions or sections of the one or more gears, based at least in part on (i) a user's pedaling speed or (ii) a position of the one or more movable portions or sections relative to a drive unit. In some embodiments, the movement of the one or more gears may comprise a movement of one or more movable portions or sections of the one or more gears. In some embodiments, the one or more movable portions or sections of the one or more gears may be configured to change a shape or a dimension of the one or more gears. In some embodiments, the one or more movable portions or sections of the one or more gears may be configured to rotate independently. In some embodiments, the one or more movable portions or sections of the one or more gears may comprise different sizes or shapes. In some embodiments, the one or more movable portions or sections may comprise (i) a first set of opposing portions or sections and (ii) a second set of opposing portions or sections. In some cases, the first set of opposing portions or sections may be distanced further from a center of the one or more gears than the second set of opposing portions or sections, to aid in alignment of the one or more gears with a drive unit of the vehicle.

In some embodiments, a first movable portion of the one or more gears may have a first set of teeth in a first spatial configuration, and a second movable portion of the one or more gears may have a second set of teeth in a second spatial configuration. In some embodiments, the first spatial configuration and the second spatial configuration may be different. In some embodiments, the first spatial configuration and the second spatial configuration may correspond to (i) a spacing between two or more teeth of the one or more gears or (ii) a positioning of one or more teeth of the one or more gears. In some embodiments, the one or more movable portions or sections may comprise a first set of opposing portions or sections having teeth in a first spatial configuration and a second set of opposing portions or sections having teeth in a second spatial configuration.

In some embodiments, a position of the one or more movable portions or sections relative to the drive unit may be detectable using a contact sensor. In some embodiments, the contact sensor may comprise a pressure sensor or a current sensor. In some embodiments, the contact sensor may be configured to detect a signal that is generated when the one or more movable portions or sections of the one or more gears contact the drive unit. In some embodiments, the one or more gears may be grounded and electrically isolated from the vehicle before the one or more movable portions or sections of the one or more gears contact the drive unit. In some embodiments, the vehicle may be energized such that a signal is generated when the one or more movable portions or sections of the one or more gears contact the drive unit.

In some embodiments, the control board may be configured to manage multiple rider profiles for different riders. In some embodiments, the control board may be configured to manage multiple rider profiles for a single rider. In some embodiments, the multiple rider profiles may comprise at least one of a racing profile, a commuting profile, or a training profile. The parameters associated with each rider profile may vary depending on a rider's preference.

In some embodiments, the control board may be configured to navigate the vehicle to a user-selected destination or along a user-selected route. In some embodiments, the control board may be configured to implement one or more applications based on vehicle data obtained using the plurality of sensors. In some embodiments, the plurality of sensors may comprise a proximity sensor for safety or navigation of the vehicle. In some embodiments, the plurality of sensors may comprise an optical sensor or an imaging unit configured for object or feature recognition.

In some embodiments, the system may further comprise a display to show rider metrics, a status of the vehicle, slope or terrain information, or a riding condition of the vehicle. In some embodiments, the riding condition may comprise a vehicle speed, a number of rotations per minute for one or more gears or wheels of the vehicle, a number of watts generated by a rider during pedaling, a gear ratio, or a torque applied to a shaft that is coupled to the one or more gears of the vehicle during pedaling.

In some embodiments, the automatic transmission described herein may be provided as an add-on package that can be installed on the vehicle. In any of the embodiments described herein, the vehicle may comprise an automobile, a truck, a tractor, an electric vehicle, a bicycle, or a motorcycle.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a block diagram of an exemplary system for communicating between a vehicle and a proximal object, in accordance with some embodiments.

FIG. 1B shows a block diagram of another exemplary system for communicating between a vehicle and a proximal object, in accordance with some embodiments.

FIG. 2 shows an example of a gear comprising one or more movable portions, in accordance with some embodiments.

FIG. 3 shows a non-limiting example of a computing device comprising one or more processors, memory, storage, and a network interface, in accordance with some embodiments.

FIG. 4 shows a non-limiting example of a web/mobile application provision system that can provide browser-based and/or native mobile user interfaces in accordance with some embodiments.

FIG. 5 shows a non-limiting example of a cloud-based web/mobile application provision system comprising an elastically load balanced, auto-scaling web server, application server resources, and synchronously replicated databases, in accordance with some embodiments.

FIG. 6 shows a non-limiting example of a smart bike comprising an automatic transmission, in accordance with some embodiments.

FIG. 7 shows another non-limiting example of a smart bike comprising one or more sensors, in accordance with some embodiments.

### DESCRIPTION OF THE EXEMPLARY EMBODIMENTS

This disclosure refers to “movement-relevant object” and “object in movement-relevant proximity.” A movement-relevant object may include, for example, a vehicle, pedestrian, person, infrastructure element, equipment component, or other item. In this disclosure, an object is in movement-relevant proximity when the system determines that the object should be considered in planning or executing movement of a movable item because the object may affect safe movement of the movable item.

The system may determine that an object is in movement-relevant proximity based on sensor data, remote data, mapped data, inferred data, compiled data, or any combination thereof. The determination may depend on the object's position, nature, motion, potential motion, or other characteristics relevant to safe movement. Any object so identified by the system is a movement-relevant object for purposes of this disclosure.

This disclosure refers to “movement-relevant object.” A movement-relevant object is an object that the system determines must be considered when planning, directing, constraining, or executing movement of a movable item. The object may include items such as a vehicle, pedestrian, person, infrastructure element, or other item.

An object is movement-relevant if its position, nature, motion, or potential motion may affect safe movement of the movable item, as determined by the system from data such as sensor data, remote data, mapped data, inferred data, compiled data, and a combination thereof. In this disclosure, the term includes any object the system may reasonably identify as requiring such consideration.

### System for Communicating Between a Vehicle and a Proximal Object

In one aspect, the present disclosure provides a system for establishing communications between a vehicle and a proximal object. The vehicle may be configured to connect with a plurality of nodes via a network. The plurality of nodes may be associated with at least one other vehicle (e.g., one or more automobiles, bicycles, or motorcycles in proximity to the vehicle), one or more pedestrians in proximity to the vehicle, and/or transportation infrastructure.

In some embodiments, the vehicle may comprise a communication device for establishing communications with one or more proximal objects. In some embodiments, the communication device may be configured to connect the vehicle with the plurality of nodes via the network. In some cases, the communications module may be integrated with the vehicle. In some cases, the communications device may be associated with a computing unit or a processing unit that is operatively coupled to the vehicle.

In some embodiments, the vehicle may comprise a processing unit that is configured to generate one or more signals based on information or data exchanged between the vehicle and the plurality of nodes. In some embodiments, the one or more signals may control an operation of the vehicle or provide an alert to an operator or a passenger of the vehicle.

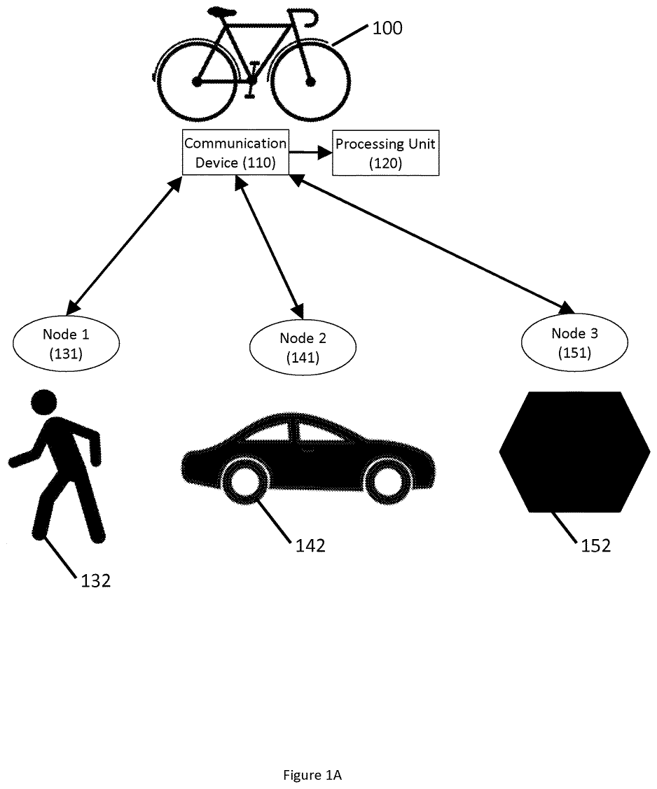

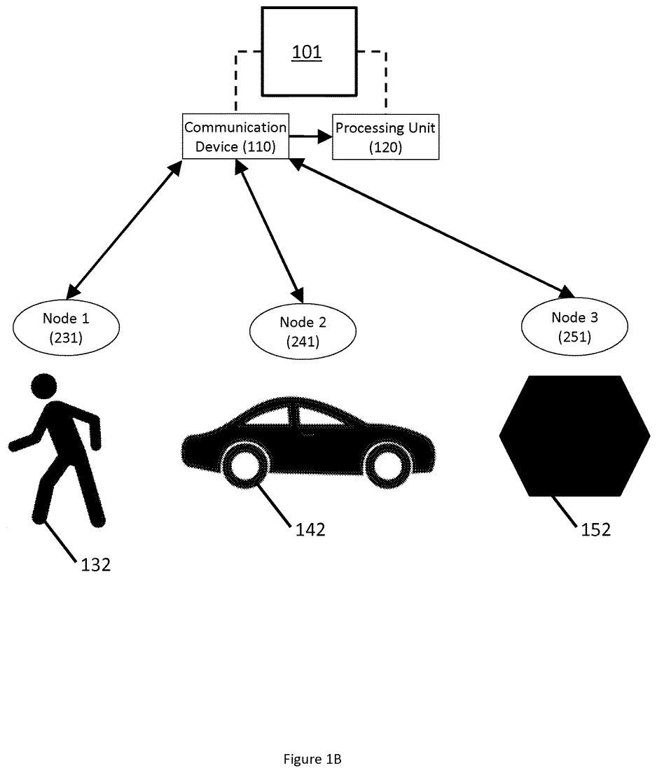

FIG. 1A shows an exemplary system comprising a communication device 110 and a processing unit 120. In some embodiments, the communication device 110, the processing unit 120, or both may be coupled to a vehicle 100. In some embodiments, the communication device 110 may be configured to connect to a plurality of nodes 131 141 151 via a network (e.g., a wireless network such as a cellular network or a WiFi or Bluetooth network). In some embodiments, each of the plurality of nodes 131 141 151 may be associated with a proximal object. The proximal object may be associated with (i) at least one other vehicle, (ii) one or more pedestrians in proximity to the vehicle, and/or (iii) transportation infrastructure.

FIG. 1B shows another exemplary system comprising a communication device 110 and a processing unit 120. In some embodiments, the communication device 110, the processing unit 120, or both may be coupled to a machine 101. The machine 101 may comprise a transmission-enabled machine. The transmission-enabled machine may comprise any type of machine that is configured to utilize a transmission or one or more gears to perform an operation. The transmission may comprise any of the smart automatic transmission as described elsewhere herein. The operation may comprise a movement of components or objects or individuals (e.g., for transportation purposes, management of equipment, production of power, or other forms of accomplishing work). The operation may comprise a mechanical or electromechanical process that can be executed by a component or a subsystem of the machine 101. In some non-limiting embodiments, the machine 101 may comprise an industrial machine or any type of vehicle. In some embodiments, the communication device 110 may be configured to connect to a plurality of nodes 131 141 151 via a network (e.g., a wireless network such as a cellular network or a WiFi or Bluetooth network). In some embodiments, each of the plurality of nodes 131 141 151 may be associated with a proximal object. The proximal object may be associated with (i) at least one other vehicle, (ii) one or more pedestrians in proximity to the vehicle, and/or (iii) transportation infrastructure.

In some embodiments, the processing unit 120 may be configured to generate a signal based on information or data exchanged between the vehicle and the plurality of nodes. In some embodiments, the processing unit 120 may be configured to generate a signal based on data (e.g., object data) received from one or more of the plurality of nodes 131 141 151. The signal may control an operation of the vehicle 100, provide an alert to a passenger of the vehicle 100, provide an alert to the proximal object or an individual associated with or proximal to the object, or any combination thereof.

In some embodiments, the vehicle 100 may comprise a bicycle, an automobile, a motorcycle, a tractor, a trailer, a camper, a snowmobile, or a boat. In some embodiments, the vehicle 100 may comprise an autonomous vehicle or a semi-autonomous vehicle. In some embodiments, the vehicle 100 may comprise a non-autonomous vehicle that can be operated based on physical or virtual inputs provided by a user or operator of the vehicle. In some embodiments, the vehicle may be configured for autonomous or semi-autonomous navigation.

In the example shown in FIG. 1A, the proximal object may comprise a proximal pedestrian 132, a proximal vehicle 142, or a proximal infrastructure 152. Node 1 131 may be associated the proximal pedestrian 132, node 2 141 may be associated with the proximal vehicle 142, and node 3 151 may be associated with the proximal infrastructure 152. In some embodiments, the proximal vehicle 142 may comprise a bicycle, an automobile, a motorcycle, a tractor, a trailer, a camper, a snowmobile, or a boat. In some embodiments, the proximal infrastructure may comprise a road, a street, a traffic signal, a road sign, a bridge, a tunnel, a fork, dead end, a junction, or any other type of infrastructure that enables or facilitates transportation.

In some embodiments, at least one node of the plurality of nodes 131 141 151 may be associated with a mobile device of a pedestrian. In some cases, the mobile device may be associated with the proximal object 132 142 152. In some embodiments, at least one node of the plurality of nodes 131 141 151 may be associated with a communication module. In some cases, the communication module may be associated with the proximal object 132 142 152. The communication module may comprise a transmitter for transmitting data, a receiver for receiving data, an antenna for facilitating data transmission or reception, and/or a transceiver for transmitting and receiving data.

In some embodiments, the processing unit 120 may be configured to generate a signal based on object data received from one or more of the plurality of nodes 131 141 151. In some embodiments, the object data may comprise a position of the object, a velocity of the object, a heading of the object, an elevation of the object, a type or classification of the object, a unique identification of the object, or any combination thereof.

In some embodiments, the processing unit 120 may be configured to generate a signal based on information or data exchanged between the vehicle and the plurality of nodes. In some cases, the information or data exchanged between the vehicle and the plurality of nodes may comprise information about a position or a movement of the at least one other vehicle or the one or more pedestrians. In some cases, the information or data exchanged between the vehicle and the plurality of nodes may comprise information on transportation infrastructure or traffic signals.

In some embodiments, the signal may control an operation of the vehicle 100. The operation of the vehicle 100 may correspond to, for example, an operation of a transmission of the vehicle 100, a steering of the vehicle 100, a speed of the vehicle 100, and/or a gear of the vehicle 100. In some embodiments, the signal may control a motion path of the vehicle 100.

In some embodiments, the one or more signals may be configured to alert the operator or the passenger of a vehicle of a presence of at least one other vehicle or one or more pedestrians proximal to the vehicle. In some embodiments, the one or more signals may be generated when the processing unit determines that a position or a movement of the at least one other vehicle or the one or more pedestrians coincides with a planned or expected motion path of the vehicle.

In some embodiments, the vehicle may comprise one or more sensors for detecting a presence of an obstacle in an environment in which the vehicle is operating. In some cases, the obstacle may comprise at least one other vehicle or the one or more pedestrians in proximity to the vehicle. In some cases, the obstacle may comprise transportation infrastructure.

In some embodiments, the processing unit 120 may be further configured to receive proximity data from an obstacle detection sensor. In some cases, the processing unit 120 may be configured to generate the signal based on the proximity data. In some embodiments, the obstacle detection sensor may comprise a LIDAR unit, a RADAR unit, an optical sensor, an inductive sensor, a capacitive sensor, a magnetic sensor, an ultrasonic sensor, or any combination thereof.

In some embodiments, the processing unit 120 may be configured to determine or detect a potential collision based on the object data, the proximity data, or both. In some cases, the processing unit 120 may generate a signal if a potential collision is determined.

In some embodiments, the processing unit 120 may be configured to receive and transmit a vehicle usage data to a platform. In some embodiments, the vehicle usage data may comprise a user identification and/or user riding data. In some embodiments, the vehicle may be configured to connect to a virtual or digital platform for health, community, and environmental awareness.

In some embodiments, the vehicle may comprise a unique ID associated with one or more physical or virtual tokens tied to a computing unit of the vehicle. In some embodiments, the one or more physical or virtual tokens may be usable to track one or more transactions involving the vehicle. The one or more transactions may involve, for example, reserving, renting, or leasing the vehicle for a certain time period.

### Methods—Connected Bike

In another aspect, the present disclosure provides a method for connecting vehicles. The method may comprise using a communications module to establish a connection between a vehicle and one or more nodes via a network. The one or more nodes may be associated with at least one other vehicle and one or more pedestrians in proximity to the vehicle. In some embodiments, the one or more nodes may be associated with transportation infrastructure.

In some embodiments, the method may comprise generating one or more signals based on information or data exchanged between the vehicle and the plurality of nodes. In some cases, the one or more signals may be used to control an operation of the vehicle or to provide an alert to an operator or a passenger of the vehicle.

In some embodiments, the vehicle may comprise a bicycle. In some embodiments, the vehicle may comprise an autonomous or semi-autonomous vehicle. In some embodiments, the at least one other vehicle may comprise one or more automobiles, bicycles, or motorcycles.

In some embodiments, the vehicle may comprise a communications module configured to connect the vehicle with the plurality of nodes via the network. In some embodiments, the communications module may be integrated with the vehicle. In some embodiments, the communications module may be associated with a computing device that is operatively coupled with the vehicle.

In some embodiments, the vehicle may comprise one or more sensors for detecting a presence of an obstacle in an environment in which the vehicle is operating. The one or more sensors may comprise, for example, an optical sensor. In some embodiments, the obstacle may comprise the at least one other vehicle or the one or more pedestrians in proximity to the vehicle. In some embodiments, the obstacle may comprise transportation infrastructure.

In some embodiments, at least one node of the plurality of nodes may be associated with a mobile device of the one or more pedestrians. In some embodiments, at least one node of the plurality of nodes may be associated with a communication module of the at least one other vehicle.

In some embodiments, the one or more signals may be configured to control an operation of a transmission of the vehicle. In some embodiments, the one or more signals may be configured to control a motion path of the vehicle. In some embodiments, the one or more signals may be configured to alert the operator or the passenger of a presence of the at least one other vehicle or the one or more pedestrians. In some embodiments, the one or more signals may be generated when a processing unit of the vehicle determines that a position or a movement of the at least one other vehicle or the one or more pedestrians coincides with a planned or expected motion path of the vehicle.

In some embodiments, the method may comprise generating one or more signals based on information or data exchanged between the vehicle and the plurality of nodes. In some embodiments, the information or data exchanged between the vehicle and the plurality of nodes may comprise information about a position or a movement of the at least one other vehicle or the one or more pedestrians. In some embodiments, the information or data exchanged between the vehicle and the plurality of nodes may comprise information on transportation infrastructure. The transportation infrastructure may comprise, for example, a traffic signal or a road sign.

### System for Controlling a Transmission of a Vehicle

In another aspect, the present disclosure provides a system for controlling an operation of a vehicle or a machine (e.g., machinery or other household or industrial machines). The system may comprise an automatic transmission for controlling an operation or a movement of a vehicle. In any of the embodiments described herein, the automatic transmission may comprise a smart automatic transmission or a Smart Connected Liner Automatic Transmission (SCLAT). The SCLAT may provide several advantages over traditional transmission systems, such as an unlimited gear ratio or an infinite number of different gear ratios. The terms “automatic transmission”, “smart automatic transmission”, and “Smart Connected Liner Automatic Transmission” or “SCLAT” may be used interchangeably herein. In some embodiments, the vehicle may comprise an electric vehicle. In some embodiments, the vehicle may comprise a combustion engine (e.g., an internal combustion engine). In some embodiments, the vehicle may comprise a terrestrial vehicle, an aquatic vehicle, or an aerial vehicle. In some embodiments, the automatic transmission may be adapted for use with EV cars, buses, trucks, or other motor vehicles such as motorcycles. In some cases, the automatic transmission may comprise one or more microprocessors.

In any of the embodiments described herein, the automatic transmission can be used with any type of vehicle to improve the ability of the vehicle to adjust an amount of power or mechanical energy transferred to a drive unit, a rotor, an axle, or a wheel of the vehicle while minimizing energy loss (e.g., due to friction). The automatic transmission may provide a number of benefits and advantages over other convention transmission systems such as, for example, continuously variable transmissions (CVTs). In contrast with CVTs, the presently disclosed automatic transmissions are completely programmable (e.g., by way of actuators or lead screws) to select or provide a greater number or range of possible gear shapes, gear sizes, or gear ratios that fit a rider's desired riding experience. The automatic transmissions disclosed herein can also operate more quickly and efficiently with less friction compared to CVTs (which can use bands/belts and pulleys), without heating up as quickly as CVTs and without the risk of slippage of components (e.g., bands) like in CVTs. CVTs may also have a significant limitation on acceleration performance (e.g., due to minimal torque output at low speeds or low rotations per unit time), whereas the smart automatic transmissions described herein can provide better acceleration performance for a vehicle that is taking off from a stationary state (i.e., zero speed or velocity). The efficiency of the automatic transmissions disclosed herein can improve the range of vehicles (e.g., electric vehicles) by at least about 10%, 20%, 30%, 40%, 50%, or more.

The smart automatic transmissions described herein can be provided as a package or a kit that can be installed in or integrated with any of the vehicles described herein. The package or kit may comprise a same or similar set of components that are compatible with multiple different types of vehicles, including bikes, motorcycles, cars, trucks, sedans, utility vehicles, hatchbacks, wagons, and the like. It is also envisioned that the smart automatic transmission may be used in machinery, where the transfer of energy may benefit from the mechanical advantage a transmission may provide, and, in particular, where smart management of the transfer of energy and the amount of leverage applied through the transmission may be monitored and controlled, as described herein.

In some embodiments, the system may further comprise a plurality of sensors and a control board. In some cases, the control board may be operatively coupled to the automatic transmission and/or the plurality of sensors. In some embodiments, the control board may be configured to control an operation of the automatic transmission based on one or more measurements obtained using at least a subset of the plurality of sensors. In some embodiments, the one or more measurements may comprise information or data on vehicle speed, velocity or acceleration, power output, wattage, or rotations per unit time.

In some embodiments, the plurality of sensors may be integrated with the automatic transmission. In other embodiments, the plurality of sensors may be configured to removably couple to the vehicle. In some embodiments, the plurality of sensors may comprise (i) one or more sensors integrated with the automatic transmission and/or (ii) one or more sensors attachable to the vehicle.

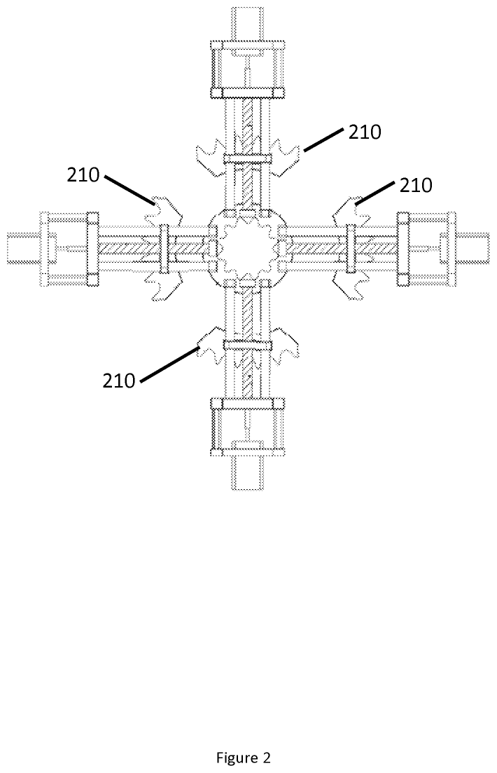

In some embodiments, the one or more measurements may comprise timing information associated with a movement of one or more movable portions 210 of a gear that is operatively coupled to the automatic transmission, as shown in FIG. 2. In some embodiments, the timing information may be obtained using the plurality of sensors, the one or more microprocessors of the automatic transmission, and/or the one or more switches. The one or more switches may comprise, for example, a mechanical switch, an electronic switch, or an electromechanical switch. In some embodiments, the one or more switches may indicate whether a movable portion or section 210 of the one or more gears is in contact with a drive unit of the vehicle. In some embodiments, the timing information may be usable to determine a time delay for expanding or contracting the one or more movable portions 210 of the gear that is operatively coupled to the automatic transmission.

In some embodiments, the automatic transmission may be configured to control a timing of an expansion or a contraction of one or more movable portions or sections 210 of the gear, based at least in part on (i) a user's pedaling speed, (ii) a position of the one or more movable portions or sections relative to a drive unit, and/or (iii) timing information or the time delay information. The drive unit may comprise, for example, a band, a belt, a cord, a rope, and a chain, or any other structure with a continual surface and two ends that may be securely joined to each other.

In some embodiments, the movement of the one or more gears may comprise a movement of one or more movable portions or sections 210 of the one or more gears. In some embodiments, the one or more movable portions or sections 210 of the one or more gears may be configured to change a shape or a dimension of the one or more gears.

In some embodiments, the one or more movable portions or sections 210 of the one or more gears may be configured to rotate independently. In some embodiments, the one or more movable portions or sections 210 of the one or more gears may comprise different sizes or shapes.

In some embodiments, the one or more movable portions or sections may comprise (i) a first set of opposing portions or sections and (ii) a second set of opposing portions or sections. In some cases, the first set of opposing portions or sections may be distanced further from a center of the one or more gears than the second set of opposing portions or sections, to aid in alignment of the one or more gears with a drive unit of the vehicle.

In some embodiments, a first movable portion of the one or more gears may have a first set of teeth in a first spatial configuration, and a second movable portion of the one or more gears may have a second set of teeth in a second spatial configuration. In some embodiments, the first spatial configuration and the second spatial configuration may be different. In some embodiments, the first spatial configuration and the second spatial configuration may correspond to (i) a spacing between two or more teeth of the one or more gears or (ii) a positioning of one or more teeth of the one or more gears. In some embodiments, the one or more movable portions or sections may comprise a first set of opposing portions or sections having teeth in a first spatial configuration and a second set of opposing portions or sections having teeth in a second spatial configuration.

In some embodiments, a position of the one or more movable portions or sections 210 relative to the drive unit may be detectable using a contact sensor. In some embodiments, the contact sensor may comprise a pressure sensor or a current sensor. In some embodiments, the contact sensor may be configured to detect a signal that is generated when the one or more movable portions or sections 210 of the one or more gears contact the drive unit.

In some embodiments, the one or more gears may be grounded and electrically isolated from the vehicle before the one or more movable portions or sections 210 of the one or more gears contact the drive unit. In some embodiments, the vehicle may be energized such that a signal is generated when the one or more movable portions or sections 210 of the one or more gears contact the drive unit. The generated signal may indicate that at least one movable portion or section of the one or more gears has engaged the drive unit. The generated signal may provide timing information that is usable to determine a time delay for expanding or contracting one or more gears operatively coupled to the automatic transmission in order to shift gears. The time delay may ensure that when various portions of the gear expand or contract, such expansion or contraction occurs in a manner that allows the teeth of the gear to seamlessly engage with the drive unit. The time delay may also ensure that when various portions of the gear expand or contract, such expansion or contraction does not break or damage the drive unit.

In some embodiments, the control board may be configured to manage multiple rider profiles for different riders. In some embodiments, the control board is configured to manage multiple rider profiles for a single rider. In some embodiments, the multiple rider profiles may comprise at least one of a racing profile, a commuting profile, or a training profile.

In some embodiments, the control board may be configured to navigate the vehicle to a user-selected destination or along a user-selected route. In some embodiments, the control board may be configured to implement one or more applications based on vehicle data obtained using the plurality of sensors. In some cases, the plurality of sensors may comprise a proximity sensor for safety or navigation of the vehicle. In some embodiments, the plurality of sensors may comprise an optical sensor or an imaging unit configured for object or feature recognition.

In some embodiments, the control board may comprise a display to show rider metrics, a status of the vehicle, slope or terrain information, or a riding condition of the vehicle. In some embodiments, the riding condition may correspond to a vehicle speed, a number of rotations per minute for one or more gears or wheels of the vehicle, a number of watts generated by a rider during pedaling, a gear ratio, or a torque applied to a shaft that is coupled to the one or more gears of the vehicle during pedaling.

In some embodiments, the automatic transmission described herein may be provided as an add-on package that can be installed on any type of vehicle. In some embodiments, the vehicle may comprise an automobile, a truck, a tractor, an electric vehicle, a bicycle, or a motorcycle. In some non-limiting embodiments, the vehicle may comprise a terrestrial vehicle, an aquatic vehicle, or an aerial vehicle.

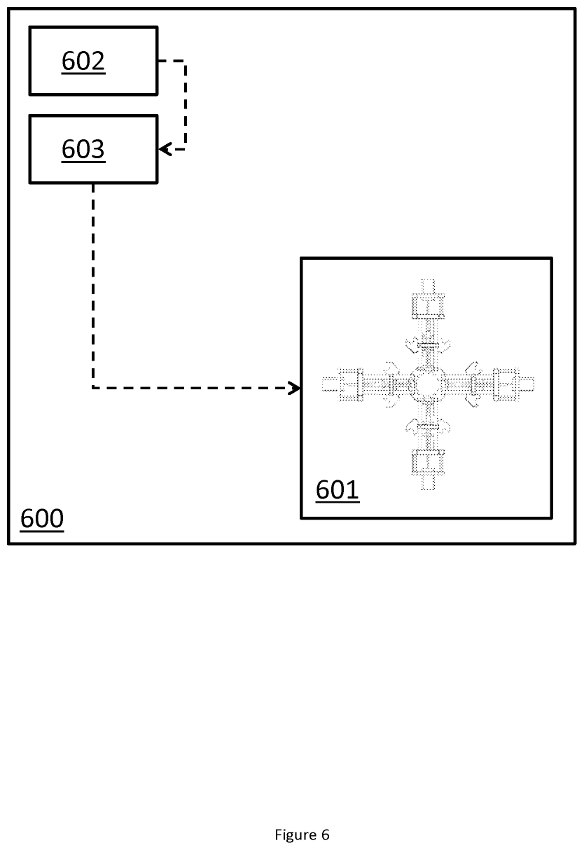

Referring to FIG. 6, in some embodiments, the smart bike 600 may comprise an automatic transmission 601 as described elsewhere herein. The smart bike 600 may further comprise one or more sensors 602 and a control board 603 that is operatively coupled to the automatic transmission 601 and/or the one or more sensors 602. The control board 603 may be operatively coupled to the one or more sensors 602. The control board 603 may be configured to control an operation of the automatic transmission 601 based on one or more readings or measurements obtained using the one or more sensors 602. In some cases, the one or more sensors 602 may be attachable to and removable from the smart bike 600. In other cases, the one or more sensors 602 may be integrated with a body, frame, structure, or component of the smart bike 600.

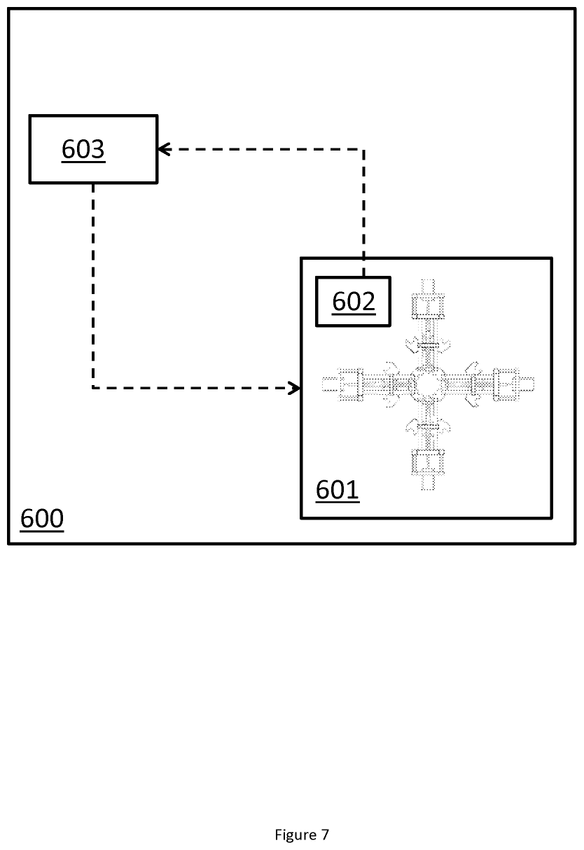

FIG. 7 shows another embodiment of a smart bike 600 comprising an automatic transmission 601, one or more sensors 602, and a control board 603 that is operatively coupled to the automatic transmission 601 and/or the one or more sensors 602. In some embodiments, the one or more sensors 602 may be integrated with the automatic transmission 601. In some cases, the one or more sensors 602 may be attachable to and removable from the automatic transmission 601.

In some embodiments, the smart bike may comprise an adaptive frame. The adaptive frame may be adjustable to change a size, a shape, or a configuration of the frame (e.g., for uphill vs downhill travel). In some cases, the adaptive frame may be configured to change a center of gravity of the bike. In some cases, the adaptive frame may be configured to change the aerodynamic properties or the drag of the smart bike. In some cases, the adaptive frame may be configured to change a distance between the seat and pedals of the bike. In some cases, the frame may be arranged into a compact configuration for storage and/or transport and expanded when ready for use. In some cases, the frame may change its shape, size, or configuration using robotic systems, actuators, motors, and the like.

In some cases, the smart bike may comprise a braking system. The braking system may be configured for regenerative braking and/or energy recovery. The energy recovered by the braking system may be used to provide boost when needed. The energy may be stored in a battery or a mechanical component (e.g., a spring) and released when a user provides an input indicating that the user wishes to utilize the stored energy. In some cases, the braking system may recover energy as a user travels downhill. In some cases, the braking system may recover energy as the user brakes softly (e.g., when the user applies the brakes with a first force), and restrict or limit the movement of the bike or the wheels of the bike when the user brakes with a second force that is greater than the first force.

In another aspect, the present disclosure provides a hybrid bike. The hybrid bike may be configured to operate as a mechanical bike, an electric bike, or anywhere in between a purely mechanical bike and a purely electric bike. In some cases, the hybrid bike may utilize sensors and/or software or firmware to adjust an amount of torque needed to pedal the bike, or to adjust a weight distribution of the bike. In some cases, the hybrid bike may utilize sensors and/or software or firmware to adjust the ride to suit a rider's preferences or needs. In some cases, the hybrid bike may be configured to adjust the operation of the bike to make the bike feel a certain weight, based on one or more sensor readings. In some cases, if a rider thinks that the bike feels heavy, then the rider can adjust the operation of the hybrid bike (e.g., by activating an electric motor) to reduce the feeling of heaviness during riding or pedaling. In some cases, the overall feel of the weight of the bike can be adjusted by using motors, or by changing a shape or a configuration of the frame, as discussed above. In some cases, the hybrid bike may be programmed for assistive pedaling. The pedaling resistance may be varied or controlled by a rider or a computer to match a user's desired amount of pedaling assistance.

In any of the embodiments described herein, the smart bike may comprise two or more automatic transmission systems. The two or more automatic transmission systems may comprise adjustable gears as described elsewhere herein. In some cases, the two or more automatic transmission systems may comprise a first automatic transmission system for a first wheel of the smart bike and a second automatic transmission system for a second wheel of the smart bike. In some cases, the friction on the chain may be reduced by utilizing the two or more automatic transmission systems that can independently adjust in size or shape to ensure that the chain is tightly wrapped around the adjustable gears. The use of two or more automatic transmission systems may obviate the need for a derailleur and increase the mechanical efficiency of the bike.

In some cases, the smart bike may comprise a first automatic transmission system for a first wheel of the smart bike and a second automatic transmission system for a second wheel of the smart bike. The first automatic transmission may comprise a first adjustable gear, and the second automatic transmission may comprise a second adjustable gear. The first adjustable and the second adjustable gear may be configured to change size and/or shape independently to modify a gear ratio between the first and second adjustable gears. In some cases, the first and second automatic transmission may collectively provide an infinite number of gear ratios for the bike, thereby enhancing the amount of control that a rider has on the operation or gear of the bike across a multitude of different riding environments and topologies.

### Methods—Smart Bike

In another aspect, the present disclosure provides a method for operating a vehicle. The method may comprise obtaining timing information associated with a movement of one or more gears operatively coupled to the automatic transmission. In some embodiments, the movement of the one or more gears may comprise a movement of one or more movable portions or sections of the one or more gears. In some embodiments, the timing information may be obtained using the plurality of sensors, the one or more microprocessors of the automatic transmission, and/or the one or more switches. The one or more switches may comprise, for example, a mechanical switch, an electronic switch, or an electromechanical switch. In some cases, the one or more switches may indicate whether a movable portion or section of the one or more gears is in contact with a drive unit of the vehicle. The drive unit may comprise, for example, a belt or a chine.

In some embodiments, the method may further comprise using the timing information to determine a time delay for expanding or contracting one or more gears operatively coupled to the automatic transmission. In some embodiments, the method may further comprise using the automatic transmission to control a timing of an expansion or a contraction of one or more movable portions or sections of the one or more gears, based at least in part on (i) a user's pedaling speed, (ii) a position of the one or more movable portions or sections relative to a drive unit, and/or (iii) the timing information or the time delay. The timing information or the time delay may ensure that when various portions of the gear expand or contract, such expansion or contraction occurs in a manner that allows the teeth of the gear to seamlessly engage with the drive unit. The timing information or time delay may also ensure that when various portions of the gear expand or contract, such expansion or contraction does not break or damage the drive unit.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount. Alternatively, the term “about” refers to an amount that is near the stated amount by 10%, 5%, or 1%, including increments therein. In some cases, the term “about” in reference to a percentage refers to an amount that is greater or less than the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Computing System

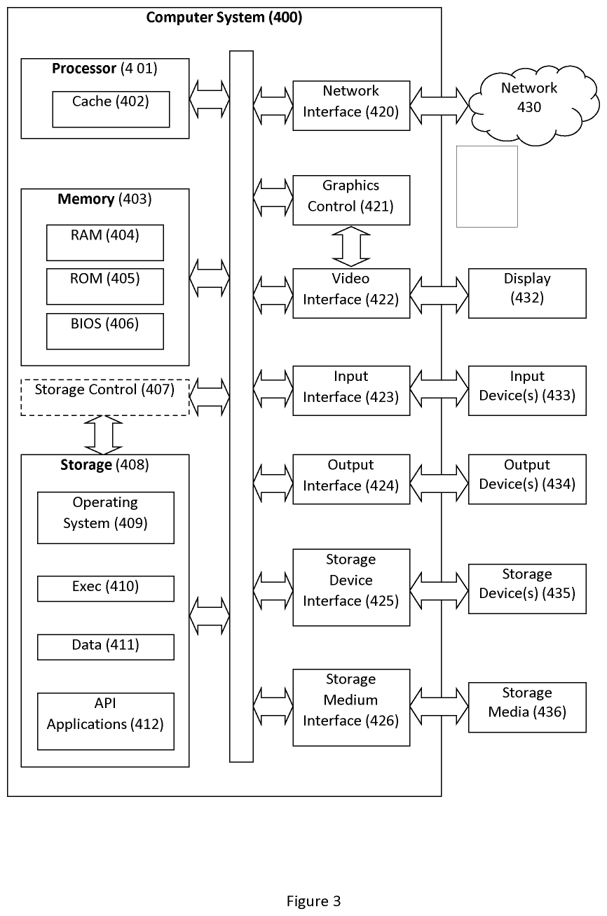

Referring to FIG. 3, a block diagram is shown depicting an exemplary machine that includes a computer system 300 (e.g., a processing or computing system) within which a set of instructions can execute for causing a device to perform or execute any one or more of the aspects and/or methodologies of the present disclosure. The components in FIG. 3 are examples only and do not limit the scope of use or functionality of any hardware, software, embedded logic component, or a combination of two or more such components implementing particular embodiments.

Computer system 300 may include one or more processors 301, a memory 303, and a storage 308 that communicate with each other, and with other components, via a bus 340. The bus 340 may also link a display 332, one or more input devices 333 (which may, for example, include a keypad, a keyboard, a mouse, a stylus, etc.), one or more output devices 334, one or more storage devices 335, and various tangible storage media 336. All of these elements may interface directly or via one or more interfaces or adaptors to the bus 340. For instance, the various tangible storage media 336 can interface with the bus 340 via storage medium interface 326. Computer system 300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 300 may include one or more processors 301 (e.g., central processing units (CPUs) or general-purpose graphics processing units (GPGPUs)) that carry out functions. Processor(s) 301 optionally contains a cache memory unit 302 for temporary local storage of instructions, data, or computer addresses. Processor(s) 301 are configured to assist in execution of computer readable instructions. Computer system 300 may provide functionality for the components depicted in FIG. 3 as a result of the processor(s) 301 executing non-transitory, processor-executable instructions embodied in one or more tangible computer-readable storage media, such as memory 303, storage 308, storage devices 335, and/or storage medium 336. The computer-readable media may store software that implements particular embodiments, and processor(s) 301 may execute the software. Memory 303 may read the software from one or more other computer-readable media (such as mass storage device(s) 335, 336) or from one or more other sources through a suitable interface, such as network interface 320. The software may cause processor(s) 301 to carry out one or more processes or one or more steps of one or more processes described or illustrated herein. Carrying out such processes or steps may include defining data structures stored in memory 303 and modifying the data structures as directed by the software.

The memory 303 may include various components (e.g., machine readable media) including, but not limited to, a random access memory component (e.g., RAM 304) (e.g., static RAM (SRAM), dynamic RAM (DRAM), ferroelectric random access memory (FRAM), phase-change random access memory (PRAM), etc.), a read-only memory component (e.g., ROM 305), and any combinations thereof. ROM 305 may act to communicate data and instructions unidirectionally to processor(s) 301, and RAM 304 may act to communicate data and instructions bidirectionally with processor(s) 301. ROM 305 and RAM 304 may include any suitable tangible computer-readable media described below. In one example, a basic input/output system 306 (BIOS), including basic routines that help to transfer information between elements within computer system 300, such as during start-up, may be stored in the memory 303.

Fixed storage 308 may be connected bidirectionally to processor(s) 301, optionally through storage control unit 307. Fixed storage 308 provides additional data storage capacity and may also include any suitable tangible computer-readable media described herein. Storage 308 may be used to store operating system 309, executable(s) 310, data 311, applications 312 (application programs), and the like. Storage 308 can also include an optical disk drive, a solid-state memory device (e.g., flash-based systems), or a combination of any of the above. Information in storage 308 may, in appropriate cases, be incorporated as virtual memory in memory 303.

In one example, storage device(s) 335 may be removably interfaced with computer system 300 (e.g., via an external port connector) via a storage device interface 325. Particularly, storage device(s) 335 and an associated machine-readable medium may provide non-volatile and/or volatile storage of machine-readable instructions, data structures, program modules, and/or other data for the computer system 300. In one example, software may reside, completely or partially, within a machine-readable medium on storage device(s) 335. In another example, software may reside, completely or partially, within processor(s) 301.

Bus 340 connects a wide variety of subsystems. Herein, reference to a bus may encompass one or more digital signal lines serving a common function, where appropriate. Bus 340 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 300 may also include an input device 333. In one example, a user of computer system 300 may enter commands and/or other information into computer system 300 via input device(s) 333. Examples of an input device(s) 333 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device comprises a Kinect unit, a Leap Motion unit, or the like. Input device(s) 333 may be interfaced to bus 340 via any of a variety of input interfaces 323 (e.g., input interface 323) including, but not limited to, serial, parallel, game port, USB, FIREWIRE, THUNDERBOLT, or any combination of the above.

In particular embodiments, when computer system 300 is connected to network 330, computer system 300 may communicate with other devices, specifically mobile devices and enterprise systems, distributed computing systems, cloud storage systems, cloud computing systems, and the like, which are connected to network 330. Communications to and from computer system 300 may be sent through network interface 320. For example, network interface 320 may receive incoming communications (such as requests or responses from other devices) in the form of one or more packets (such as Internet Protocol (IP) packets) from network 330, and computer system 300 may store the incoming communications in memory 303 for processing. Computer system 300 may similarly store outgoing communications (such as requests or responses to other devices) in the form of one or more packets in memory 303 and communicated to network 330 from network interface 320. Processor(s) 301 may access these communication packets stored in memory 303 for processing.

Examples of the network interface 320 include, but are not limited to, a network interface card, a modem, and any combination thereof. Examples of a network 330 or network segment 330 include, but are not limited to, a distributed computing system, a cloud computing system, a wide area network (WAN) (e.g., the Internet, an enterprise network), a local area network (LAN) (e.g., a network associated with a geographical area or environment), a telephone network, a direct connection between two computing devices, a peer-to-peer network, and any combinations thereof. A network, such as network 330, may employ a wired and/or a wireless mode of communication. In general, any network topology may be used.

Information and data can be displayed through a display 332. Examples of a display 332 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 332 can interface to the processor(s) 301, memory 303, and fixed storage 308, as well as other devices, such as input device(s) 333, via the bus 340. The display 332 is linked to the bus 340 via a video interface 322, and transport of data between the display 332 and the bus 340 can be controlled via the graphics control 321. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 332, computer system 300 may include one or more other peripheral output devices 334 including, but not limited to, an audio speaker, a printer, a storage device, and any combinations thereof. Such peripheral output devices may be connected to the bus 340 via an output interface 324. Examples of an output interface 324 include, but are not limited to, a serial port, a parallel connection, a USB port, a FIREWIRE port, a THUNDERBOLT port, and any combinations thereof.

In addition, or as an alternative, computer system 300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of ordinary skill in the art appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processors, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung@ HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processors of the computing device's CPU, written to perform a specified task. Computer readable instructions may be implemented as program modules, such as functions, objects, Application Programming Interfaces (APIs), computing data structures, and the like, that perform particular tasks or implement particular abstract data types. Considering the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, the computer program may include a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

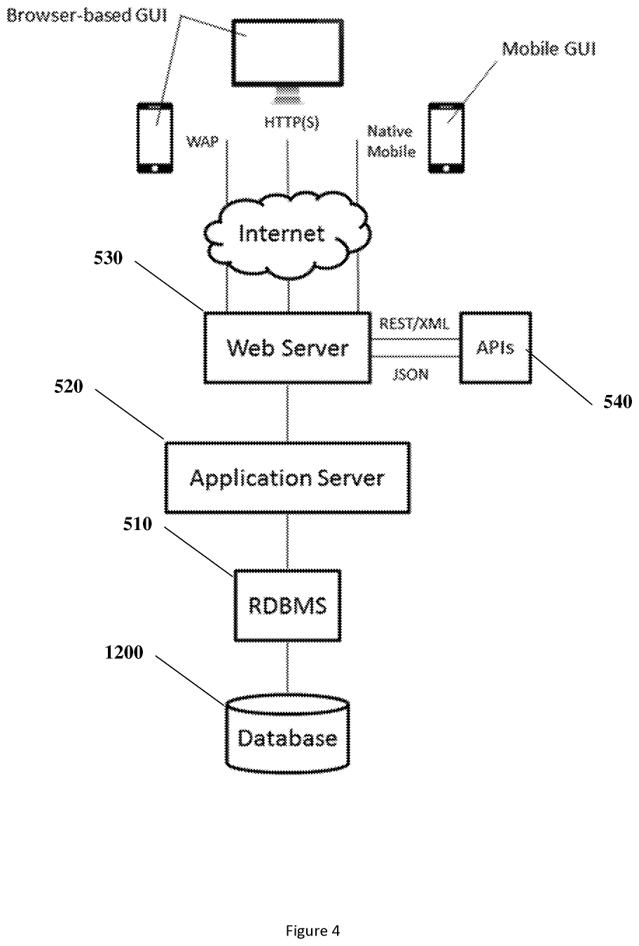

Referring to FIG. 4, in a particular embodiment, an application provision system comprises one or more databases 400 accessed by a relational database management system (RDBMS) 410. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application servers 420 (such as Java servers, .NET servers, PHP servers, and the like) and one or more web servers 430 (such as Apache, IIS, GWS and the like). The web server(s) optionally expose one or more web services via app application programming interfaces (APIs) 440. Via a network, such as the Internet, the system provides browser-based and/or mobile native user interfaces.

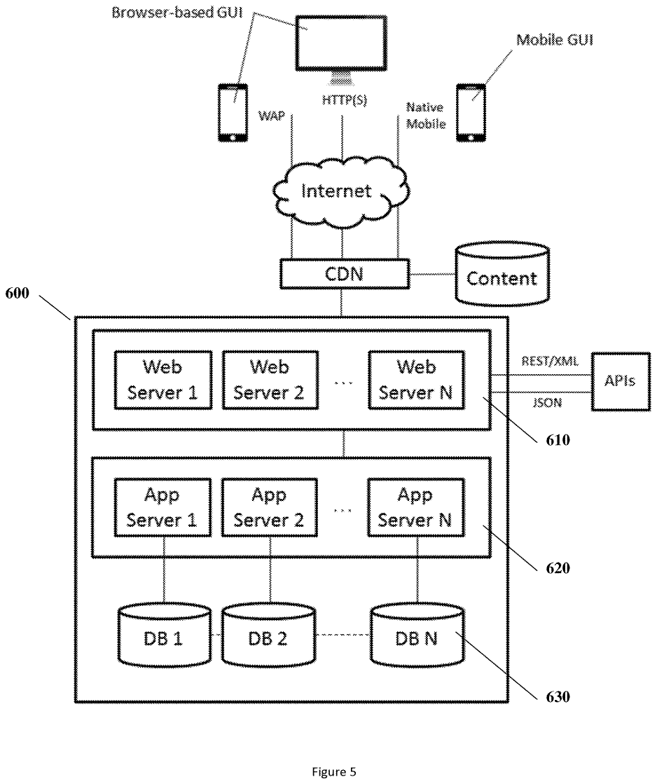

Referring to FIG. 5, in an alternative embodiment, the application provision system may comprise a distributed, cloud-based architecture 500 and may comprise elastically load balanced, auto-scaling web server resources 510 and application server resources 520 as well synchronously replicated databases 530.

### Mobile Application

In some embodiments, the computer program may comprise a mobile application provided to a mobile computing device. In some embodiments, the mobile application may be provided to a mobile computing device at the time it is manufactured. In other embodiments, the mobile application may be provided to a mobile computing device via a network as described herein.

In view of the disclosure provided herein, the mobile application may be created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB. NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, the computer program may comprise a standalone application, which may comprise a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program may comprise a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of ordinarly skill in the art will be familiar with several web browser plug-ins including, Adobe® Flash® Player, Microsoft® Silverlight®, and Apple@ QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

### Software Modules

In some embodiments, the platforms, systems, media, and methods disclosed herein may be implemented by way of software, servers, and/or database modules. In view of the disclosure provided herein, software modules can be created by techniques known to those of skill in the art using machines, software, and languages known in the art. The software modules disclosed herein can be implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein may be implemented by way of one or more databases. In view of the disclosures provided herein, those of skill in the art will recognize that many databases are suitable for storage and retrieval of vehicle infrastructure and pedestrian information. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

The examples contained in this specification are merely possible implementations of the current system, and alternatives to the particular features, elements and process steps, including scope and sequence of the steps may be changed without departing from the spirit of the invention. The present invention should only be limited by the examined and allowed claims, and their legal equivalents, since the provided exemplary embodiments are only examples of how the invention may be employed, and are not exhaustive.

Here are some inexhaustive descriptions of systems that fall within the scope of the invention, and which may be considered for claim development. A system comprising a vehicle configured to connect with a plurality of nodes via a network, wherein the plurality of nodes are associated with at least one other vehicle and one or more pedestrians in proximity to the vehicle, wherein the vehicle comprises a processing unit configured to generate one or more signals based on information or data exchanged between the vehicle and the plurality of nodes, wherein the one or more signals control an operation of the vehicle or provide an alert to an operator or a passenger of the vehicle. That first exemplary system wherein the vehicle comprises a bicycle or an autonomous or semi-autonomous vehicle. That system wherein the at least one other vehicle comprises one or more automobiles, bicycles, or motorcycles. That first exemplary system wherein the plurality of nodes are associated with transportation infrastructure. That first exemplary system wherein the vehicle comprises a communications module configured to connect the vehicle with the plurality of nodes via the network.

One of the embodiments of that first exemplary system wherein the communications module is integrated with the vehicle. That embodiment of that system wherein the communications module is associated with a computing device that is operatively coupled to the vehicle.

The first exemplary system wherein the vehicle comprises one or more sensors for detecting a presence of an obstacle in an environment in which the vehicle is operating. That first exemplary wherein the obstacle comprises the at least one other vehicle or the one or more pedestrians in proximity to the vehicle, or that first exemplary system wherein the obstacle comprises transportation infrastructure, or that first exemplary system wherein the one or more sensors comprise an optical sensor.

The first exemplary system wherein at least one node of the plurality of nodes is associated with a mobile device of the one or more pedestrians, or a communication module of the at least one other vehicle. The first exemplary system wherein the one or more signals are configured to control an operation of a transmission of the vehicle, or to control a motion path of the vehicle, or to alert the operator or the passenger of a presence of the at least one other vehicle or the one or more pedestrians.

The first exemplary system wherein the one or more signals are generated when the processing unit determines that a position or a movement of the at least one other vehicle or the one or more pedestrians coincides with a planned or expected motion path of the vehicle. The first exemplary system wherein the information or data exchanged between the vehicle and the plurality of nodes comprises information about a position or a movement of the at least one other vehicle or the one or more pedestrians, or information on transportation infrastructure. That first exemplary system wherein the transportation infrastructure comprises a traffic signal or a road sign.

The first exemplary system wherein the vehicle is configured to connect to a virtual or digital platform for health, community, and environmental awareness.

That first exemplary system wherein the vehicle is configured for autonomous navigation. That first exemplary system wherein the vehicle comprises a unique ID associated with one or more physical or virtual tokens tied to a computing unit of the vehicle. That first exemplary system wherein the one or more physical or virtual tokens are usable to track one or more transactions involving the vehicle.

A second exemplary system comprising an automatic transmission for controlling an operation or a movement of a vehicle or a machine, wherein the automatic transmission comprises one or more microprocessors, the system also having a plurality of sensors and a control board operatively coupled to the automatic transmission and/or the plurality of sensors, wherein the control board is configured to control an operation of the automatic transmission based on one or more measurements obtained using at least a subset of the plurality of sensors. That second exemplary system wherein the plurality of sensors is integrated with the automatic transmission, or wherein the plurality of sensors is attachable to the vehicle.

That second exemplary system wherein the plurality of sensors comprise (i) one or more sensors integrated with the automatic transmission and (ii) one or more sensors attachable to the vehicle. The second exemplary system wherein the one or more measurements comprise information or data on vehicle speed, velocity or acceleration, power output, wattage, or rotations per unit time. c the one or more measurements comprise timing information associated with a movement of one or more gears operatively coupled to the automatic transmission. That second exemplary system further having one or more switches, wherein the one or more switches comprise a mechanical switch, an electronic switch, or an electromechanical switch. That second exemplary system wherein the timing information is obtained using the plurality of sensors, the one or more microprocessors of the automatic transmission, and/or the one or more switches. Or, that second exemplary system wherein the one or more switches indicate whether a movable portion or section of the one or more gears is in contact with a drive unit of the vehicle.

The second exemplary system wherein the timing information is usable to determine a time delay for expanding or contracting one or more gears operatively coupled to the automatic transmission. That second exemplary system wherein the automatic transmission is configured to control a timing of an expansion or a contraction of one or more movable portions or sections of the one or more gears, based at least in part on (i) a user's pedaling speed or (ii) a position of the one or more movable portions or sections relative to a drive unit. That second exemplary system wherein the movement of the one or more gears comprises a movement of one or more movable portions or sections of the one or more gears; or wherein the one or more movable portions or sections of the one or more gears are configured to change a shape or a dimension of the one or more gears; or wherein the one or more movable portions or sections of the one or more gears are configured to rotate independently; or wherein the one or more movable portions or sections of the one or more gears comprise different sizes or shapes; or wherein the one or more movable portions or sections comprise (i) a first set of opposing portions or sections and (ii) a second set of opposing portions or sections, wherein the first set of opposing portions or sections is distanced further from a center of the one or more gears than the second set of opposing portions or sections, to aid in alignment of the one or more gears with a drive unit of the vehicle; or wherein a first movable portion of the one or more gears has a first set of teeth in a first spatial configuration, and wherein a second movable portion of the one or more gears has a second set of teeth in a second spatial configuration.

That second exemplary system wherein the first spatial configuration and the second spatial configuration are different; or wherein the first spatial configuration and the second spatial configuration correspond to (i) a spacing between two or more teeth of the one or more gears or (ii) a positioning of one or more teeth of the one or more gears.

One of the second exemplary systems wherein the one or more movable portions or sections comprise a first set of opposing portions or sections having teeth in a first spatial configuration and a second set of opposing portions or sections having teeth in a second spatial configuration or wherein the drive unit comprises a belt or a chain. Then that second exemplary system, wherein a position of the one or more movable portions or sections relative to the drive unit is detectable using a contact sensor. Then that second exemplary system, wherein the contact sensor comprises a pressure sensor or a current sensor; or wherein the contact sensor is configured to detect a signal that is generated when the one or more movable portions or sections of the one or more gears contact the drive unit. Then that second exemplary system wherein the one or more gears are grounded and electrically isolated from the vehicle before the one or more movable portions or sections of the one or more gears contact the drive unit, or even wherein the vehicle is energized such that the signal is generated when the one or more movable portions or sections of the one or more gears contact the drive unit.

One of the second exemplary systems wherein the control board is configured to manage multiple rider profiles for different riders. One of the second exemplary systems wherein the control board is configured to manage multiple rider profiles for a single rider, which also wherein the multiple rider profiles comprise at least one of a racing profile, a commuting profile, or a training profile.

One of the second exemplary systems wherein the control board is configured to navigate the vehicle to a user-selected destination or along a user-selected route; or wherein the control board is configured to implement one or more applications based on vehicle data obtained using the plurality of sensor; or wherein the plurality of sensors comprise a proximity sensor for safety or navigation of the vehicle; or wherein the plurality of sensors comprise an optical sensor or an imaging unit configured for object or feature recognition; or wherein further comprising a display to show rider metrics, a status of the vehicle, slope or terrain information, or a riding condition of the vehicle, which may be then wherein the riding condition comprises a vehicle speed, a number of rotations per minute for one or more gears or wheels of the vehicle, a number of watts generated by a rider during pedaling, a gear ratio, or a torque applied to a shaft that is coupled to the one or more gears of the vehicle during pedaling.

One of the second exemplary systems wherein the automatic transmission is provided as an add-on package that can be installed on the vehicle; or wherein the vehicle comprises an automobile, a truck, a tractor, an electric vehicle, a bicycle, or a motorcycle; or wherein the vehicle comprises an electric vehicle; or wherein the vehicle comprises an internal combustion engine; or wherein the automatic transmission provides at least about a 10% increase in range for the vehicle compared to a continuously variable transmission (CVT); or wherein the automatic transmission is provided as a kit or a package configured to integrate with one or more components or subsystems of a plurality of different types of vehicles; or wherein the machine comprises household or industrial machinery.

An exemplary system, according to this description, may be described as a transmission system for a machine operable by an operator in an environment, the transmission system comprising a gear operatively connected to the machine to control movement of the machine, one or more movable portions of the gear, a microprocessor, a sensor configured to obtain measurement data, and a control board operatively coupled to the gear and the sensor, wherein the control board is configured to control an operation of the gear based on the measurement data, wherein the environment includes one or more movement-relevant objects, and wherein the movement-relevant object is an object that the system determines must be considered when planning, directing, constraining, or executing movement of the machine because the object's position, nature, motion, potential motion, or combination thereof may affect safe movement of the machine.

An exemplary system, according to this description, may additionally include that the measurement data comprises one or more of a portion position, a gear ratio, an operational speed, a velocity, an acceleration of the machine, an operator profile, a power output, an operational wattage of the operator, a rate of rotation of the gear, a torque applied to the gear, position data for a movement-relevant object, velocity data for a movement-relevant object, heading data for a movement-relevant object, elevation data for a movement-relevant object, type data for a movement-relevant object, unique identification data for a movement-relevant object, status data for the machine, size data for the machine, shape data for the machine, configuration data for the machine, slope data of the environment, condition data of the environment, or any combination thereof.

An exemplary system, according to this description, may additionally include that a position of at least one of the one or more movable portions establishes an operation of the gear. Such an exemplary system may include that the movement-relevant object comprises another machine, a vehicle, an object, a pedestrian, or an infrastructure element. Such an exemplary system may include a communication device and a plurality of nodes configured for communication over a network, each node of the plurality of nodes being associated with a sensor of a movement-relevant object. Such an exemplary system may include that the sensor of the movement-relevant object is configured to obtain the measurement data, and wherein the communication device is configured to transfer the measurement data from the plurality of nodes to the control board. Such an exemplary system may include that processing unit operatively connected to the communication device and the control board, wherein the processing unit is configured to use the measurement data in conjunction with computer-readable instructions to control the operation of the gear based on the measurement data. Such an exemplary system may include that the sensor comprises a contact sensor, a pressure sensor, a current sensor, a proximity sensor, an optical sensor, an imaging unit, a LIDAR unit, a RADAR unit, an inductive sensor, a capacitive sensor, a magnetic sensor, or an ultrasonic sensor. Such an exemplary system may include that a control board is configured to determine whether the movement-relevant object coincides with or is expected to coincide with a planned or expected motion path of the machine. Such an exemplary system may include that the control board is configured to generate a signal when the movement-relevant object coincides with or is expected to coincide with the planned or expected motion path. Such an exemplary system may include that a control board is configured to control at least one of a transmission operation, a steering operation, a speed operation, a gear operation, or a motion path of the machine. Such an exemplary system may include that the machine comprises a bicycle, an automobile, a motorcycle, a truck, a tractor, an electric vehicle, an aquatic vehicle, an aerial vehicle, or an industrial machine.

An exemplary system, according to this description, may be described as a method for controlling a transmission system for a machine operable by an operator in an environment, the method comprising, obtaining measurement data from a sensor operatively associated with a gear of the machine, determining, by a processing unit, whether an object in the environment is a movement-relevant object, and controlling, by a control board operatively coupled to the gear and the sensor, an operation of the gear based on the measurement data, wherein the movement-relevant object is an object that should be considered when planning, directing, constraining, or executing movement of the machine because the object's position, nature, motion, potential motion, or combination thereof may affect safe movement of the machine.

An exemplary method, according to this description, may additionally include that measurement data comprises one or more of a portion position, a gear ratio, an operational speed, a velocity, an acceleration of the machine, an operator profile, a power output, an operational wattage of the operator, a rate of rotation of the gear, a torque applied to the gear, or data associated with the movement-relevant object. Such an exemplary method may include receiving, over a network, additional object data from a plurality of nodes associated with the movement-relevant object. Such an exemplary method may include that the additional object data comprises position data, velocity data, heading data, elevation data, type data, unique identification data, or any combination thereof. Such an exemplary method may include determining that the movement-relevant object coincides with or is expected to coincide with a planned or expected motion path of the machine. Such an exemplary method may include generating a signal when the movement-relevant object coincides with or is expected to coincide with the planned or expected motion path. Such an exemplary method may include wherein the machine comprises a bicycle, an automobile, a motorcycle, a truck, a tractor, an electric vehicle, an aquatic vehicle, an aerial vehicle, or an industrial machine.

An exemplary system, according to this description, may be described as non-transitory computer-readable medium having instructions stored thereon that, when executed by a processing unit, cause a transmission system to perform operations comprising obtaining measurement data from a sensor operatively associated with a gear of a machine, determining whether an object in an environment of the machine is a movement-relevant object, and controlling an operation of the gear based on the measurement data, wherein the movement-relevant object is an object that should be considered when planning, directing, constraining, or executing movement of the machine because the object's position, nature, motion, potential motion, or combination thereof may affect safe movement of the machine.

An exemplary system, according to this description, may additionally include that the instructions further cause the processing unit to receive object data from a plurality of nodes associated with the movement-relevant object over a network. Such an exemplary system may include that the instructions further cause the processing unit to generate a signal based on the object data to control at least one of a transmission operation, a steering operation, a speed operation, a gear operation, or a motion path of the machine. Such an exemplary system may include that the instructions further cause the processing unit to determine a planned or expected motion path for the machine and to compare the movement-relevant object to the planned or expected motion path. Such an exemplary system may additionally include that the machine comprises a bicycle, an automobile, a motorcycle, a truck, a tractor, an electric vehicle, an aquatic vehicle, an aerial vehicle, or an industrial machine.

The examples contained in this specification are merely possible implementations of the current system, and alternatives to the particular features, elements, and process steps, including the scope and sequence of the steps, may be changed without departing from the spirit of the invention. The present invention should only be limited by the examined and allowed claims, and their legal equivalents, since the provided exemplary embodiments are only examples of how the invention may be employed, and are not exhaustive.

What is claimed is:

1. A transmission system for a machine operable by an operator in an environment, the transmission system comprising:
a gear operatively connected to the machine to control movement of the machine;
one or more movable portions of the gear;
a microprocessor;
a sensor configured to obtain measurement data; and
a control board operatively coupled to the gear and the sensor;
wherein the control board is configured to control an operation of the gear based on the measurement data;
wherein the environment includes one or more movement-relevant objects; and
wherein the movement-relevant object is an object that the system determines must be considered when planning, directing, constraining, or executing movement of the machine because the object's position, nature, motion, potential motion, or combination thereof may affect safe movement of the machine.

2. The transmission system of claim 1, wherein the measurement data comprises one or more of a portion position, a gear ratio, an operational speed, a velocity, an acceleration of the machine, an operator profile, a power output, an operational wattage of the operator, a rate of rotation of the gear, a torque applied to the gear, position data for a movement-relevant object, velocity data for a movement-relevant object, heading data for a movement-relevant object, elevation data for a movement-relevant object, type data for a movement-relevant object, unique identification data for a movement-relevant object, status data for the machine, size data for the machine, shape data for the machine, configuration data for the machine, slope data of the environment, condition data of the environment, or any combination thereof.

3. The transmission system of claim 1, wherein a position of at least one of the one or more movable portions establishes an operation of the gear.

4. The transmission system of claim 1, wherein the movement-relevant object comprises another machine, a vehicle, an object, a pedestrian, or an infrastructure element.

5. The transmission system of claim 1, further comprising a communication device and a plurality of nodes configured for communication over a network, each node of the plurality of nodes being associated with a sensor of a movement-relevant object.

6. The transmission system of claim 5, wherein the sensor of the movement-relevant object is configured to obtain the measurement data, and wherein the communication device is configured to transfer the measurement data from the plurality of nodes to the control board.

7. The transmission system of claim 5, further comprising a processing unit operatively connected to the communication device and the control board, wherein the processing unit is configured to use the measurement data in conjunction with computer-readable instructions to control the operation of the gear based on the measurement data.

8. The transmission system of claim 1, wherein the sensor comprises a contact sensor, a pressure sensor, a current sensor, a proximity sensor, an optical sensor, an imaging unit, a LIDAR unit, a RADAR unit, an inductive sensor, a capacitive sensor, a magnetic sensor, or an ultrasonic sensor.

9. The transmission system of claim 1, wherein the control board is configured to determine whether the movement-relevant object coincides with or is expected to coincide with a planned or expected motion path of the machine.

10. The transmission system of claim 9, wherein the control board is configured to generate a signal when the movement-relevant object coincides with or is expected to coincide with the planned or expected motion path.

11. The transmission system of claim 1, wherein the control board is configured to control at least one of a transmission operation, a steering operation, a speed operation, a gear operation, or a motion path of the machine.

12. The transmission system of claim 1, wherein the machine comprises a bicycle, an automobile, a motorcycle, a truck, a tractor, an electric vehicle, an aquatic vehicle, an aerial vehicle, or an industrial machine.

13. A method for controlling a transmission system for a machine operable by an operator in an environment, the method comprising:
obtaining measurement data from a sensor operatively associated with a gear of the machine;
determining, by a processing unit, whether an object in the environment is a movement-relevant object; and
controlling, by a control board operatively coupled to the gear and the sensor, an operation of the gear based on the measurement data;
wherein the movement-relevant object is an object that should be considered when planning, directing, constraining, or executing movement of the machine because the object's position, nature, motion, potential motion, or combination thereof may affect safe movement of the machine.

14. The method of claim 13, wherein the measurement data comprises one or more of a portion position, a gear ratio, an operational speed, a velocity, an acceleration of the machine, an operator profile, a power output, an operational wattage of the operator, a rate of rotation of the gear, a torque applied to the gear, or data associated with the movement-relevant object.

15. The method of claim 13, further comprising receiving, over a network, additional object data from a plurality of nodes associated with the movement-relevant object.

16. The method of claim 15, wherein the additional object data comprises position data, velocity data, heading data, elevation data, type data, unique identification data, or any combination thereof.

17. The method of claim 13, further comprising determining that the movement-relevant object coincides with or is expected to coincide with a planned or expected motion path of the machine.

18. The method of claim 17, further comprising generating a signal when the movement-relevant object coincides with or is expected to coincide with the planned or expected motion path.

19. The method of claim 13, wherein the machine comprises a bicycle, an automobile, a motorcycle, a truck, a tractor, an electric vehicle, an aquatic vehicle, an aerial vehicle, or an industrial machine.

20. A non-transitory computer-readable medium having instructions stored thereon that, when executed by a processing unit, cause a transmission system to perform operations comprising:
obtaining measurement data from a sensor operatively associated with a gear of a machine;
determining whether an object in an environment of the machine is a movement-relevant object; and
controlling the operation of the gear based on the measurement data;
wherein the movement-relevant object is an object that should be considered when planning, directing, constraining, or executing movement of the machine because the object's position, nature, motion, potential motion, or combination thereof may affect safe movement of the machine.
